(19) United States
(12) Patent Application Publication
(10) Pub. No.: US 2007/0147277 A1
(43) Pub. Date: Jun. 28, 2007

(54) Asynchronous and automatic device and method for transmission of results between communicating objects

(75) Inventors: Denis Caromel, Antibes (FR); Romain Quilici, Entrecasteaux (FR); Christian Delbe, Nice (FR); Ludovic Henrio, Harrow Middlesex (GB)

Correspondence Address: FOLEY AND LARDNER LLP;SUITE 500, 3000 K STREET NW, WASHINGTON, DC, 20007, US

(73) Assignee: Inria Institut National De Recherce En Informatiq-

(21) Appl. No.: 10/580,256

(22) PCT Filed: Nov. 24, 2004
(86) PCT No.: PCT/FR04/03005

§ 371 Date: Feb. 1, 2007

(30) Foreign Application Priority Data
Nov. 26, 2003 (FR) 0313876

(51) Int. Cl. H04B 7/14

(52) U.S. Cl. 370/315

(57) ABSTRACT

The invention relates to a method for managing remote method calls in object-oriented languages, by means of an asynchronous communication between a local process of a station and a remote process on another station, such a call comprising a request from one of the processes, followed by a reply from the other process. The method comprises a) detecting the transmission of an empty object as request or reply parameter before the transmission thereof from a local process to a remote process (710), calculating the content of said empty object the provision of which was requested for an expert process, b) processing of said empty object in order to make the content of said object (712) available to the remote process and c) carrying out the transmission of said request, or said reply on condition of appropriate processing.

The invention relates to the field of communication by remote procedure calls (RPC) between a local process and a remote process.

These RPC-type communications can use objects in object-oriented language. In the field of RPC-type communications, a process known as caller sends a request to a process being called, the caller process blocking its execution until it receives the result of its request by the called process.

Within the scope of the invention, communications established between the processes are of the asynchronous RPC type, i.e. the source process proceeds to execution thereof after sending (or lodging) a request (known as the call message). Thus, in the case of a request, the target process first completes the execution of its current tasks, then carries out the remote procedure in parallel with carrying out the source process and makes available the parameters of the response at the end of carrying out the remote procedure. The source process can thus obtain its response parameters.

However, this type of asynchronous RPC communication does not provide for communication management of these results between processes, which may lead to blockages when the execution of operations or the sending of messages requires these results.

The invention aims to improve the situation.

The invention relates to a call management process for remote procedures in object-oriented language, by asynchronous communication, between a local process of one station and a remote process of another station, such a call comprising a request from one of the processes followed by a response from the other process, this method consisting

a—in detecting the transmission of an empty object as a parameter of a request or of a response before sending of the same from a local process to a remote process, the calculation of the content of this empty object and its being made available having been requested of a knowing process,

b—in processing the empty object with a view to making available the content of this object to the remote process,

c—in proceeding to send the said request or response upon an appropriate condition of processing.

The invention also relates to a computer station, comprising
an environment capable of carrying out one or more local processes in object-oriented language
a protocol module, capable of processing, by an asynchronous communication, remote procedure calls between a local process and a remote process of another station, such a call comprising a request of one of the processes, followed by a response of the other process.

According to one feature of the invention, the computer station comprises: A monitor capable—upon detection of the event that an empty object is occurring as parameter of a request or of a response to be sent by the local process to the remote process, the calculation of the content of this empty object and its making available having been requested of a knowing process—of
processing the empty object with a view to making available the content of this object to the remote process,
pursuing sending of the request or of the response upon an appropriate condition of processing.

The computer device according to the invention may comprise numerous additional features which can be taken separately and/or in combination and which will be explained in the detailed description below.

Further features and advantages of the invention will appear from a study of the detailed description below, as well as from the attached drawings, which show:

FIG. 1, a network of stations communicating by asynchronous remote procedure calls (RPC),

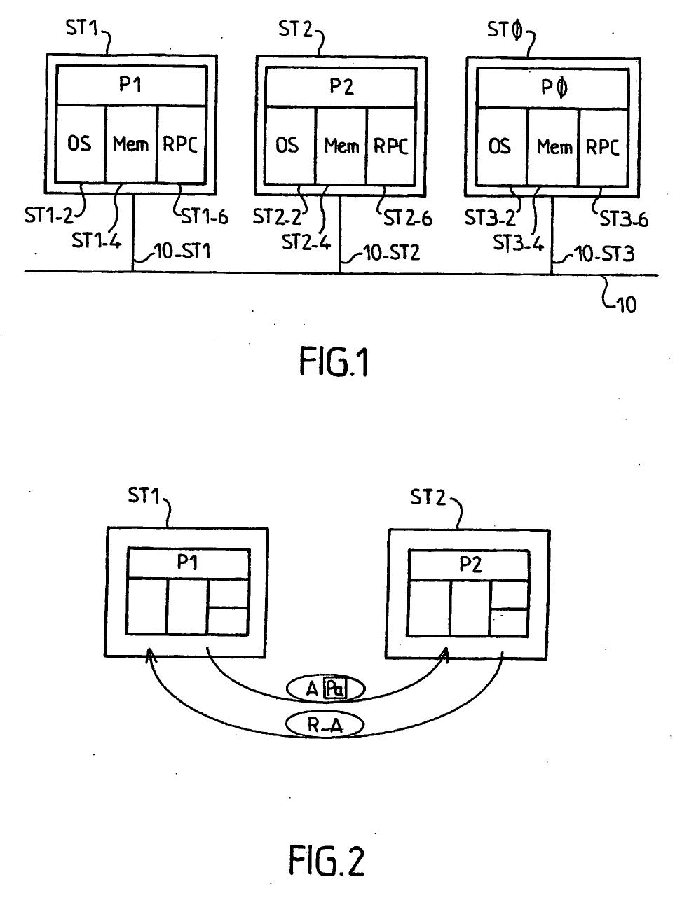

FIG. 2, the communication between two stations of FIG. 1 using the asynchronous remote procedure call (RPC),

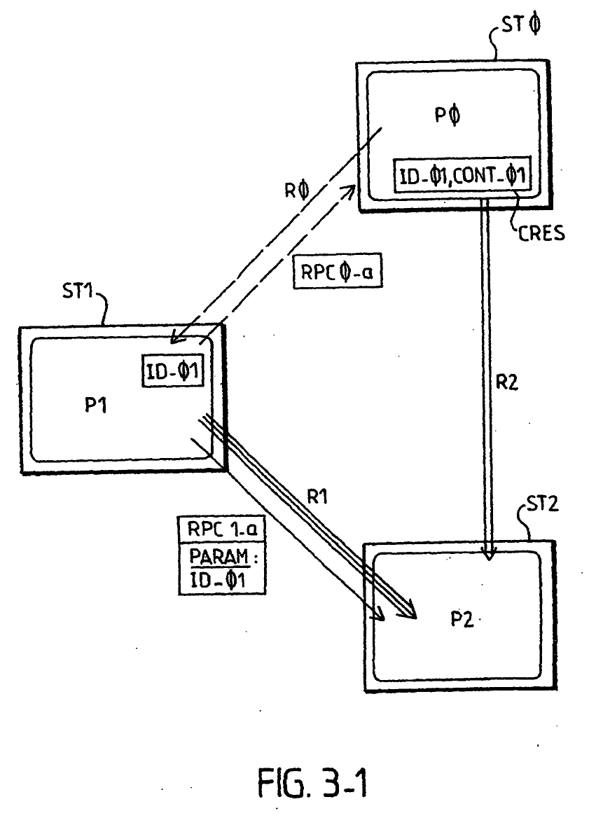

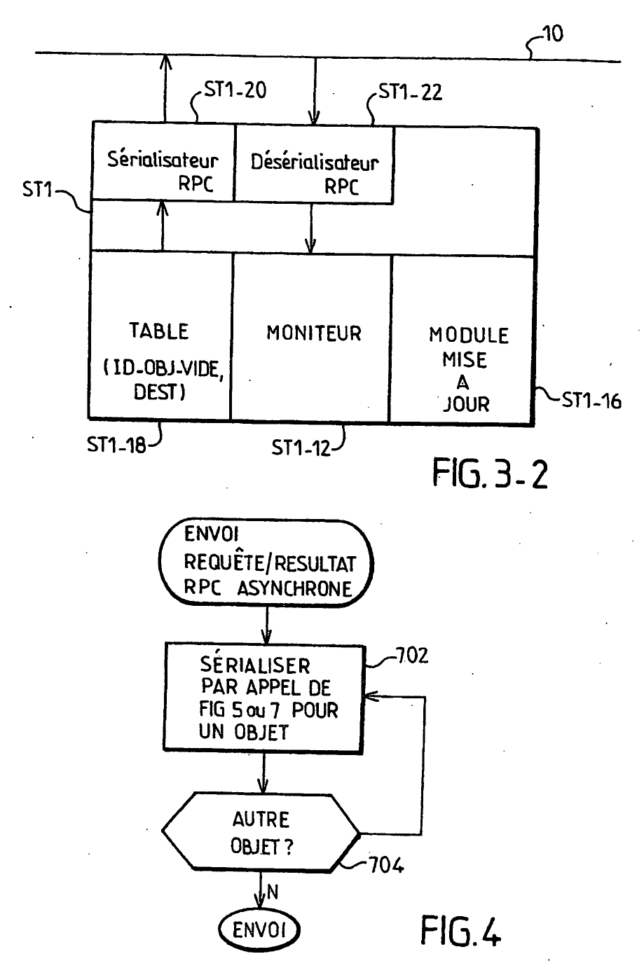

FIG. 3-1, a network of stations using the asynchronous remote procedure call (RPC) with return of results according to the invention,

FIG. 3-2, components of a station according to the invention in detail,

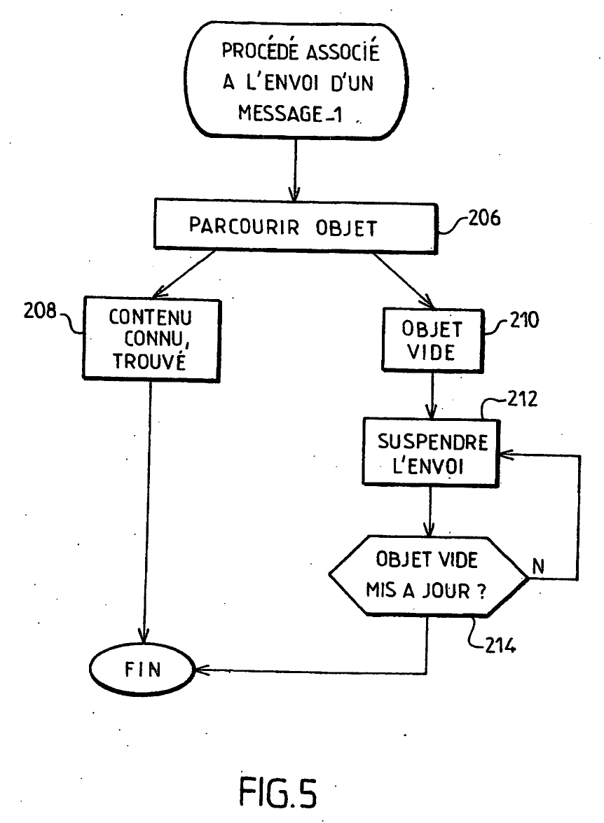

FIG. 4, a flow chart showing the method of sending a request or result for asynchronous RPC communications,

FIG. 5, a flow chart detailing a first embodiment of a method associated with sending and called at the stage 702 of FIG. 4,

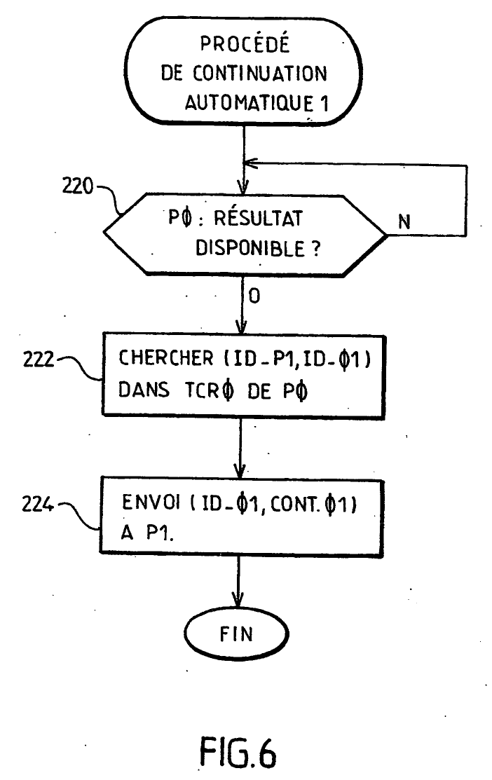

FIG. 6, a flow chart detailing a first embodiment of a method of automatic continuation of results which is associated with the first embodiment of the method of FIG. 5,

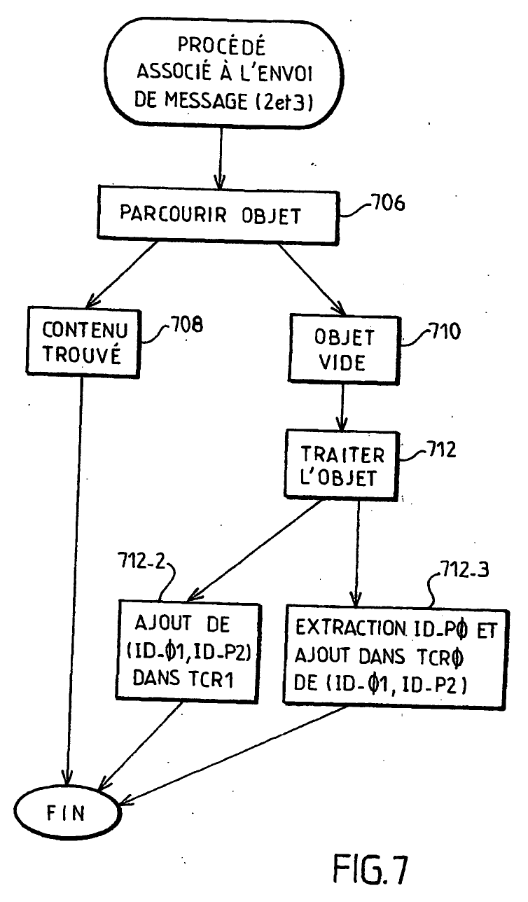

FIG. 7, a flow chart detailing a second and third embodiment of the method associated with sending and called at stage 702 of FIG. 4,

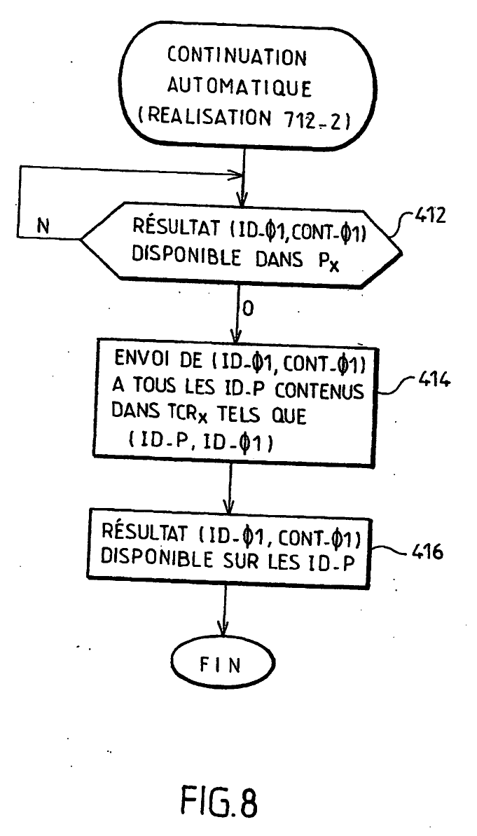

FIG. 8, a flow chart detailing a second embodiment of the method of automatic continuation of results which is associated with the second embodiment of the method of FIG. 7,

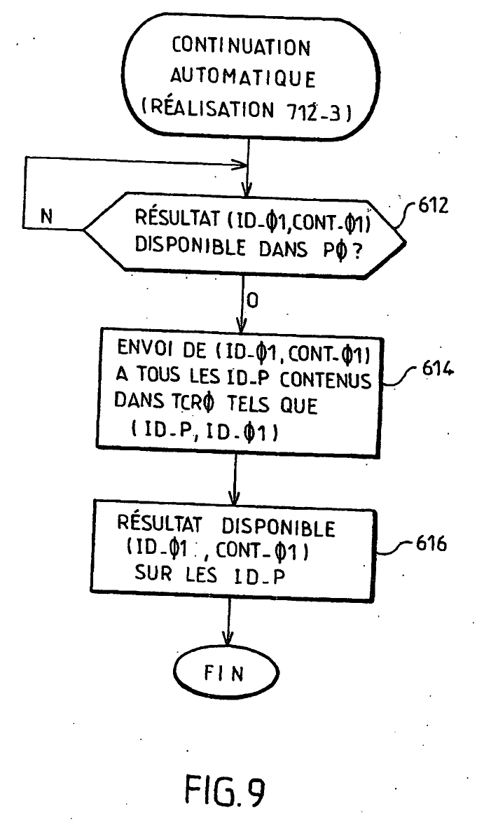

FIG. 9, a flow chart detailing a third embodiment of the method of automatic continuation of results which is associated with the third embodiment of the method of FIG. 7,

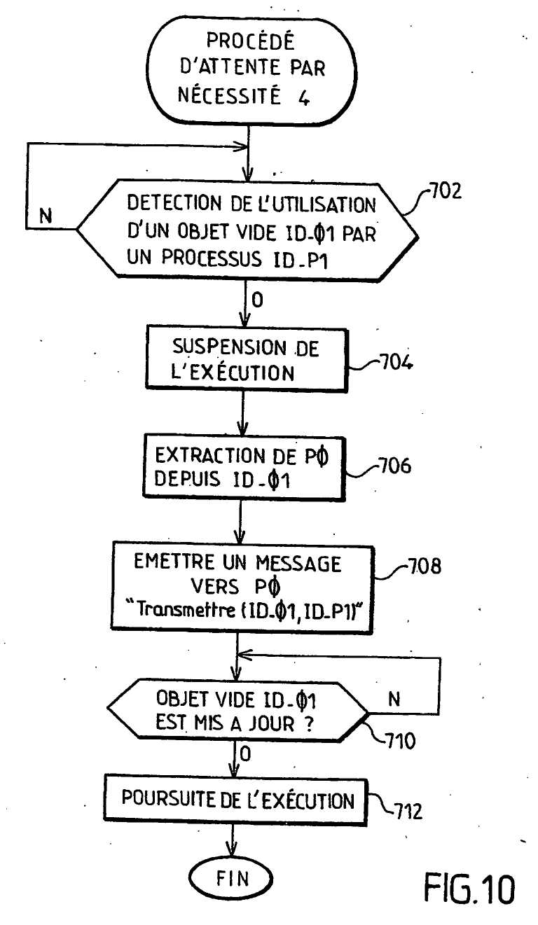

FIG. 10, a flow chart detailing a method of waiting out of necessity for the result according to the invention,

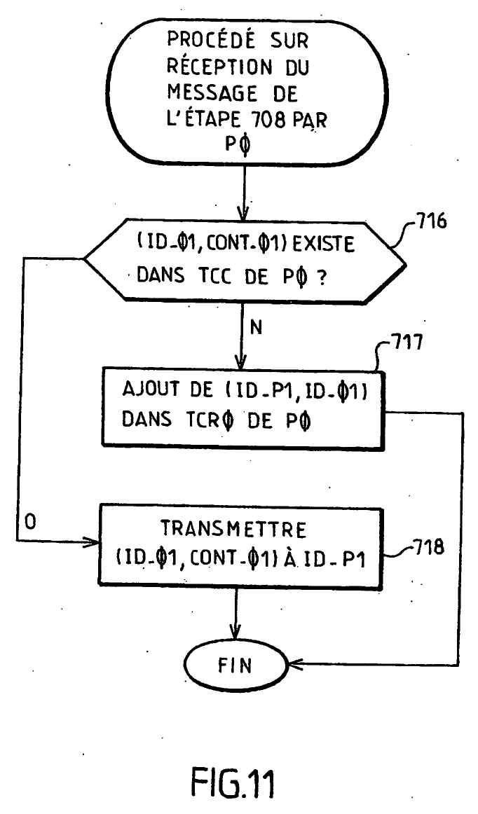

FIG. 11, a method of receiving a message after sending of a message from the stage 708 of FIG. 10,

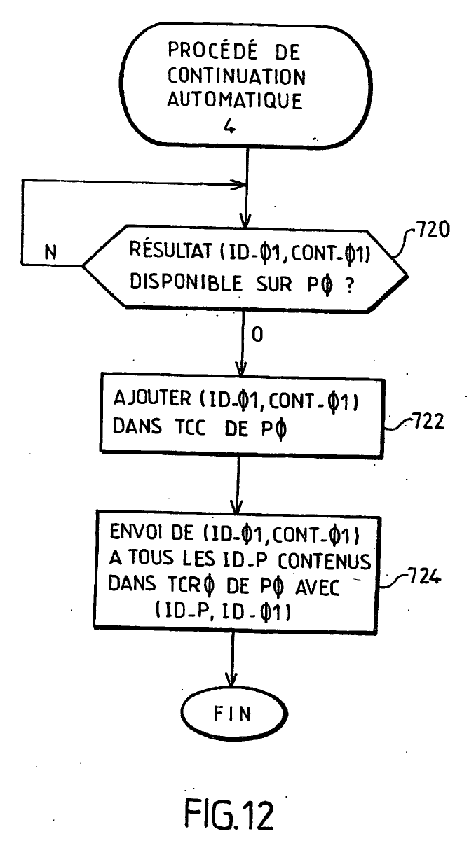

FIG. 12, flow chart detailing a fourth embodiment of the method of automatic continuation of results which is associated with the methods of FIGS. 10 and 11.

The drawings contain, essentially, elements of a definite character. They may therefore not only aid an understanding of the description, but also contribute to the definition of the invention if need be.

FIG. 1 shows a network of intercommunicating stations. “Computer station” is taken to mean any IT element capable of exchanging data. Thus, this element might be a mobile communication terminal such as a mobile telephone or a portable computer, or on the contrary a fixed communication terminal, such as a PC-type computer. Each station ST1, ST2, ST0 comprises a user system ST1-2, ST2-2, ST0-2, a non-shared memory ST1-4, ST2-4, ST0-4, a process P1, P2, P0 operating in object-oriented language, and a communications protocol module ST1-6, ST2-6, ST0-6 of the communications by RPC-type (for Remote Procedure Call) asynchronous remote procedure calls, the module being capable of operating with objects in object-oriented language. This protocol module is capable of processing, by an asynchronous communication, RPC remote procedure calls between a local process and a remote process of another station. The protocol module comprises a library of objects comprising methods or functions for remote procedure calls. The term “process” designates a programme of instructions which may comprise procedure calls, or operations by way of example. The environment formed by a user system ST1-2, a non-shared memory ST1-4 and a communications protocol module ST1-6 make it possible to carry out local processes such as P1 in object-oriented language.

Each station is connected to the other stations by a link which may be physical or virtual, e.g. cables, optical fibres or radio waves. More particularly, and by way of example, each station may be connected to a network 10 by a link 10-ST1, 10-ST2, 10-ST0, the stations being interconnected.

As is shown in FIG. 2, the asynchronous RPC-type protocol module makes it possible for a process P1 known as client to call a procedure of the process P2 known as server located remotely in the station ST2. This call A is also known as a request and comprises parameters Pa. In the object-oriented language, a request is an object representing a procedure call and comprising the procedure and the parameters of calls. In order that the call of this procedure resembles a call of a local procedure, the client process P1 comprises an object having a local procedure of the same name as the remote procedure to be called. This local procedure of the station ST1 calls certain procedures in the object library of the protocol module, e.g. a Java®-type library. These take care of the network connections, the passage of parameters Pa and the return of results also known as RES response. Upon an asynchronous RPC-type call, the client process P1 lodges the request with its call parameters in the station ST2, then continues its execution. On the side of the station ST2, the server process P2 finishes the execution of its current tasks before calling the local procedure of the station ST2 with the call parameters and returning the response R-A, i.e. the result to the station ST1.

Thus the client process P1 does not call the local procedure but only lodges a request at the station ST2, then continues its execution. In a parallel manner, the server process P2 continues its execution current at the time of lodging of the request, then responds to the request by sending a response to the client process P1.

Obviously, any process of the network uses the library of the protocol module of the asynchronous RPC type to establish communications by remote procedure calls. In general, any process can be both client and server, i.e. to transmit a request and to receive one. Therefore, one refers to a source or local process when the process sends requests or responses, or a target or remote process when the process receives requests or responses.

The communications set up between the processes are of the asynchronous type, i.e. the source process carries out its execution after sending (or lodging) a request (call message). Thus, in the case of a request, the target process first completes the execution of its current tasks, then carries out the remote procedure in parallel with the execution of the source process and makes available the parameters of the response upon completion of execution of the remote procedure. The source process can thus obtain its response parameters.

Within the scope of asynchronous RPC-type communications using objects in the object-oriented language, when a process sends a request, the response may be delayed, which may block execution of the process. A process cannot wait for the response to a request and use the representation of this response which is not yet determined. In general, an object is identified by an identifier and comprises a structure which may be either empty, or have a content (values of parameters, procedures). Thus the representation of a response not yet determined may be an object identifier indicated as empty or partially empty. This object is connected to a flag indicating that this object is empty or partially empty. The object may be completely empty, i.e. an object whose content is still unknown, or partially empty, i.e. an object whose content is only partially known. This empty object identifier names an object whose content, or at least part thereof, will be the response to a given request.

A request or response sent by a local process to a remote process may have parameters comprising one or more empty object identifiers. More particularly, a request sent by a client process to a server process may have parameters comprising one or more empty object identifiers. In the same way, a response sent by a server process to a client process may have parameters comprising one or more empty object identifiers. In these cases, it is important that the remote processes can obtain the content of these empty objects once these are available.

In some cases, it is indispensable to learn the content of an empty object, for example, when an empty object identifier is used by a process. By “use” of an empty object identifier, an operation is meant for which it is necessary to determine the content of this object. An operation is known as strict and may be, in a non-limiting example, an addition, a subtraction, a division, or a multiplication if the identifier of the object names an object representing a number. In the case of use, it is necessary that the process can obtain the content of the empty object in order to carry out the operation.

A management mechanism for the transmission of contents of empty objects to processes needing the same seems necessary.

FIG. 3-1 shows the network of stations of FIG. 1. The references identical to those of FIG. 1 designate the same elements.

The asynchronous RPC communications between the processes P1 and P0 described now are shown by arrows in dashed lines.

When an asynchronous RPC-type call RPC0-a is made, the source process P1 creates an empty object identifier ID-01 representing the response to the request RPC0-a, serialises the request as is shown in FIG. 4 described below, lodges at the station ST0 the request RPC0-a with its call parameters, which comprise the empty object identifier ID-01, then continues its execution. In the station ST0, the request is received, deserialised, then placed on hold in a file of requests to be processed by the target process P0. Thus the calculation of the content of this empty object and its being made available are requested of the target process also called knowing process, in particular upon generation of the request RPC0-a. When the content of the empty object is obtained by the target process P0, the result couple CRES comprising the content CONT-01, and the identifier ID-01 of the empty object is made available. The target process P0 obtains the content CONT-01 of the empty object by calculation and is called the knowing process.

The process P0 can also store the identifier of the process P1 associated with the empty object identifier in order to send the result back to the process P1 by the response R0.

The content CONT-01 may itself contain the identifier of another empty object whose content will be calculated by another process.

Once the empty object is created in the process P1, the identifier of this object can be either used by the process P1 or passed as a parameter into a request RPC1-a to the target process P2 as is indicated in FIG. 3-1.

When the content of the empty object is known by the process P1, this updates the empty object by integrating the content into the structure of the empty object.

FIG. 3-2 shows in more detail the modules capable of operating in relation with the process P1.

The station comprises the following processes:
a detector, e.g. a serialiser ST1-20, in contact with the process P1 and capable of detecting the event that an empty object identifier is occurring as a parameter of a request or response to be sent by the local process P1 to another, remote process P2,
an updating module ST1-16 capable, from the identifier of an empty object and from the determined content of this empty object, of integrating this content into the structure of the empty object and thus to update the empty object,
a monitor ST1-12 linked to the detector ST1-20 and the local process P1 and capable, in response to the detection of the detector, of intercepting the sending, in processing the empty object with a view to making available the content of this object to the remote process and of proceeding to the sending of the request or response upon an appropriate condition of processing.

The processing of the empty object, which will be discussed further below, comprises either
waiting for the content and halting of execution of the event during this waiting time, the appropriate condition of processing corresponding to the receipt of the content or updating of the empty object by integration of its content once received.

storage of data which identify the empty object and a process to which the content of the empty object must be directed, the execution of the event being then pursued without the content of the empty object being known,
the fact of continuing the execution of the event.

In the case of use of an empty object identifier by the process P1, the detection of this use is automatically realised since access to this empty object is blocked by the semantics of the object language. The processing reserved after detection of such use will be discussed further below.

The monitor comprises an assembly of processes known as intervention processes which are carried out according to whether the process is a source or a knowing process, a knowing process being that which calculates the content of an empty object. The monitor comprises a process known as waiting out of necessity, a process known as associated with the sending of a request/result, and a process known as automatic continuation. The execution of the last process can be effected in parallel with and independently of the other processes. This process of automatic continuation has the purpose of forwarding the determined contents of empty objects to all processes likely to need the same.

The monitor operates furthermore with at least one table known as Table of Contents to be Retransmitted TCR indicating the identifier of empty objects and the identifier of a process. This table is used to transmit the content of the empty object to the process identified. Such a table will be used either in the knowing process or in all the processes having transmitted an empty object identifier, e.g. a source process, according to the embodiment of the invention as will be discussed further below.

In the case of the request RPC0-a of FIG. 3-1 for example, the process P0 adds to its Table of Contents to be Retransmitted TCR0 the couple comprising the identifier ID-01 of the empty object and the identifier ID-P1 of the source process to which the content of the empty object must be sent.

The functions of the various components are detailed in the description of the flow charts of FIGS. 4 to 12 given below. The description will be given in parallel with FIG. 3-1.

For the embodiments of FIGS. 4-9, one is in the situation of FIG. 3-1 in the case where the process P1 has sent a request RPC0-a to the knowing process P0 and seeks to send to the process P2 a request RPC1-a comprising the identifier ID-01 of the empty object or in the case where the process P1 has received an empty object identifier ID-01 created by another process of the network.

FIG. 4 shows the serialisation of a request or response before its being sent. At the stage 702, a first object from the parameters of the request or response to be sent is serialised. The serialisation mechanism, which makes it possible to send the request or response after copying the same, comprises in particular detection of an empty object. To this detection is added management of this empty object by virtue of the call of a process associated with the sending of a message according to FIG. 5 or FIG. 7 for example. If, at the stage 704, the parameters of the request or the response comprise other objects, these are also serialised by recursive call of the process of FIG. 5 or FIG. 7 before the sending of the request or response.

FIGS. 5 and 6 show a first embodiment of the monitor according to the invention. This embodiment is applied upon sending empty objects by a source process through the parameters of a request or response. This mode may be called “Waiting for attempt to transmit”.

Upon the serialisation of the request or response according to FIG. 4, FIG. 5 proposes a process associated with the sending of a message (request or response) according to a first embodiment. By way of example, this message may be the message RPC1-a of FIG. 3-1 having for a parameter an empty object identifier ID-01 and sent by the process P1 to the process P2. In the message, the structure of a first object is has run through to stage 206. If the structure of the object comprises a known content at the stage 208, the serialisation mechanism of the stage 704 of FIG. 4 continues. If the structure of the object does not have a fully-known content, e.g. the object contains a flag indicating that the object is empty as in the case of RPC1-a, the object is detected as an empty object at the stage 210. The sending of the request or response is therefore suspended at the stage 212 for as long as the empty object is not updated in the source process P1 at the stage 214. The process returns to the stage 704 of FIG. 4 to serialise another object of the request or response. Once all the objects of the request or response have been serialised, the sending of the message is carried out, e.g. the sending of the message RPC1-a of the process P1 to the process P2.

In this embodiment, the monitor of the process P1 is capable of awaiting the receipt of a message sent by the knowing process, the message comprising the content and the identifier of the empty object, said receipt being the appropriate processing condition.

FIG. 6 shows an automatic continuation process according to the first embodiment of the invention. In FIG. 3-1, one is in the position of the source process P1 having sent a request RPC0-a to a knowing process P0 to find out the content of an empty object identifier ID-01. When the knowing process P0 handles the request, it checks whether the content of the empty object identified by ID-01 is available. As soon as this is available at the stage 220, the table TCR0 of the knowing process P0 is searched for the identifier of the source process associated with the identifier ID-01 of the empty object. Thus, the content and the identifier of the empty object are sent to the source process P1. The data of the table TCR0 are deleted gradually as the content of the empty objects is sent to the processes listed in this table.

Once this result is received by the process P1, its updating module updates the empty object by integrating the content into the structure of the object before proceeding to sending of the request RPC1-a to the process P2 as is indicated by the methods of FIGS. 4 and 5.

For each object of the request or response, FIG. 7 proposes a second and third realisation of the method associated with the sending of a message (request or response). The second realisation may be entitled “Transmission of results by processes transmitting empty objects” and the third realisation may be entitled “Passage with order of retransmission by processes transmitting empty objects”. One is in the situation of the message RPC1-a comprising an empty object identifier ID-01 and sent from the process P1 to the process P2. The structure of an object of the message has run through to the stage 706 by the serialiser of the process P1. If the structure of the object has a known content at the stage 708, the serialisation mechanism of stage 704 of FIG. 7 continues. If the structure of the object has no known content or has a content which is partly known, e.g. the object comprises a flag indicating that the object is empty, the object is detected as an empty object at the stage 710. This is then referred to as interception of sending in the case of sending of a request or response. The empty object is then processed at the stage 712 by the monitor ST1-12. This processing comprises plural options according to the realisation of the method
either, at stage 712-2, storage in a local table or list known as the Table of Contents to be Retransmitted TCR, e.g. TRC1 linked to the process P1, of the empty object identifier and of the identifier of the destination process, e.g. ID-P2, to which the content of this object must be sent,
or, at the stage 712-3, starting from the empty object identifier, e.g. ID-01, extraction of the identifier of the knowing process, e.g. P0 (called knowing), capable of calculating the content of this empty object and adding to the table TCR of the knowing process, e.g. TCR0 of the process P0, the empty object identifier and the identifier of the destination process to which the content of this object must be sent. This addition may be effected after the sending of a message from the source process to the knowing process, e.g. from the process P1 to the process P0, asking the knowing process to transmit the content of the object to the destination process, e.g. P2.

In the case of the stage 712-2, the Table of Contents to be Retransmitted TCR of the source process P1 contains the couples of empty object identifiers ID-OBJ-VID associated with the target process identifiers ID-P, to which the content of at least one empty object must be retransmitted. The monitor ST1-12 adds the couple (ID-P2, ID-01) to the table TCR1 of the source process P1. This addition corresponds to an appropriate condition of processing, which triggers the sending of the request RPC1 to the target process P2.

In the case of the stage 712-3, the identifier of the knowing process P0 is extracted from the empty object identifier ID-01. The couple (ID-01, ID-P2) is added to the Table of Contents to be Retransmitted TCR0 of the knowing process P0. To this end, the source process P1 may send a message to the knowing process P0 requesting retransmission of the result comprising the identifier and the content of the empty object to the target process P2. Upon an appropriate condition of processing, which may be extraction of the identifier of the knowing process for a given empty object, sending of the message requesting retransmission, or addition to the table TCR0 of the couple (ID-01, ID-P2), the source process P1 sends the request RPC1 to the target process P2.

At the moment of extraction of the identifier of the knowing process P0, the source process P1 can inform the target process P2 of the identifier of the knowing process P0 if this has no extraction method. Thus, if the empty object identifier is used as a parameter of a request by the process P2, the latter can ask the knowing process for direct transmission of the content of the empty object to the next target process.

FIG. 8 shows a second embodiment of the method of automatic continuation linked to the method associated with sending of a message realising the processing of the stage 712-2 of FIG. 7.

This method is carried out for each process Px, x being an integer which can designate the knowing process P0 and any process which has retransmitted the empty object ID-01, i.e. a process P1, P2.

At the stage 412, the monitor of the process Px is in a phase of waiting for the availability of the result comprising the identifier and the content of the empty object (ID-01, CONT-01). Once this result is available in the process Px, the updating module thereof updates the object by integrating the content into the structure of the object and by a message (e.g. the message R1 between the process P1 and the process P2 in FIG. 3-1) sends this updated object to all the target processes, i.e. all the processes whose identifiers ID-P in the table TCRx are associated with the identifier of the empty object ID-01 at the stage 414. Thus, at the stage 416, the result becomes available in all the target processes.

In an iterative manner, the target processes which have retransmitted the empty object wait for the result at the stage 412, i.e. the updated empty object. As soon as these target processes receive this result, they become source processes by carrying out the stage 414, i.e. they retransmit the updated empty object by a message to all the target processes of their table TCR whose identifiers ID-P are associated with the empty object identifier ID-01. This iteration is carried out until all the processes which have retransmitted the empty object receive the updated object.

The process is first carried out by the knowing process and then, in an iterative manner, by any process which has retransmitted the empty object and receives the updated object.

Thus, this embodiment makes it possible to retransmit the content of the empty object by a source process to the target process as soon as the content is available in the source process and the update of the empty object has been carried out by the source process. This retransmission can be carried out in an iterative manner and by a synchronous RPC-type communication.

FIG. 9 shows a third embodiment of the method of automatic continuation linked to the method associated with the sending of a message realising the processing of the stage 712-3 of FIG. 7.

In FIG. 9, at the stage 612, the monitor of the knowing process P0 is in a waiting phase for the result of the request RPC0-a to be made available. This result comprises the identifier and the content of the empty object (ID-01, CONT-01). Once this result is available in the knowing process P0, the updating module thereof updates the empty object by integrating the content into the structure of the object and the monitor sends this updated object by a message R2 to all the target processes, i.e. to all the processes whose identifiers ID-P in the table TRC0 are associated with the empty object identifier ID-01 at the stage 614. Thus, at the stage 616, the updated object becomes available locally in all the target processes.

In this embodiment of the invention the monitor of the computer station of the local process is capable, after executing the sending of the request or response and once the content of the empty object is available in the local process, of sending the empty object identifier associated with its content to the processes whose identifiers in the table are associated with the empty object identifier.

FIGS. 10, 11 and 12 illustrate a fourth embodiment of the invention which is applied to the detection of use of an empty object by the process P1 by way of example. In this embodiment, the method associated with the sending of a message (request or response) does not require particular processing and the sending is carried out in the presence or otherwise of a detected empty object.

FIG. 10 illustrates a method of waiting out of necessity according to the fourth embodiment of the invention. At the stage 702, the use by a process P1 of an empty object identified by ID-01 is detected. At the stage 704, the execution of the process P1 is suspended. At the stage 706, the monitor of the process P1 extracts from the identifier ID-01 of the empty object the identifier of the knowing process ID-P0 capable of calculating and making available the content of the empty object. At the stage 708, the monitor of the process P1 transmits to the knowing process P0 a first message Transmit (ID-01, ID-P1) with the identifier ID-01 of the empty object and the identifier ID-P1 of the process P1. This message requires, once the content of the empty object is made available, transmission by the process P0 to the process P1 of a second message (ID-01, CONT-01) with the identifier and content of the empty object. At the stage 710, the monitor of the process P1 waits for the empty object to be updated by the updating module of the process P1. This updating of the empty object corresponds to an appropriate condition of processing that the monitor detects in order to carry out the execution of the use made of the object identified at stage 712.

FIG. 11 illustrates the method of receipt of the first message of the stage 708 by the knowing process P0. At the stage 716, the monitor of the process P0 checks whether the content CONT-01 of the identified object ID-01 in the first message received is present in the Table of Contents Calculated TCC held by the knowing process P0 as is indicated in FIG. 12. If this is the case, the monitor recovers the content of the empty object and its identifier from the table TCC and, at the stage 718, sends a second message comprising the identifier and the content of the empty object (ID-01, CONT-01) to the process P1 using this object.

If this is not the case, at the stage 717, the monitor of the process P0 adds to its Table of Contents to be Retransmitted TCR0 the couple of data (ID-P1, ID-01) which has been turned into parameters with the first message.

FIG. 12 illustrates a method of automatic continuation according to the fourth embodiment of the invention. Thus at the stage 720, the monitor of the knowing process P0 is waiting for the result (ID-01, CONT-01) comprising the identifier and content of the empty object to be become available. Once this result is available, it is added to the table TCC of the knowing process P0 at the stage 722 then sent to all the processes of the table TCR0 of P0 for which the identifiers are associated with the empty object identifier. In other words, the process P0 calculates in one go the content of the empty object and then sends the couple identifier-content of the empty object to all the processes waiting for the result by virtue of the tables TCC and TCR0 held in the memory by the knowing process P0.

Thus, the monitor of the computer station of the knowing process is capable of operating with a first table TCR0 comprising couples of data associating the empty object identifiers and process identifiers and a second table TCC comprising couples of data associating empty object identifiers and the contents of these objects. The monitor of the computer station of the knowing process is also able, once it has added to the second table the identifier of the empty object and its calculated content, to transmit a message containing the identifier and content of the empty object
to the local process after checking that the empty object identifier is in the second table and
to the processes whose identifier in the first table is associated with the empty object identifier, these identifiers having been added to the first table upon a message of the process P1.

This embodiment of the monitor of the invention using the tables TCC and TCR makes possible overall management of the processes waiting for the same content of an empty object identified for the use of this object.

Although there is a reference to tables of data, the term “table” may also designate a list of inter-associated data and the term “list” may also designate a table of data.

Thus these embodiments make is possible to retransmit the content associated with an empty object to all the processes having an identifier of this empty object as soon as the content has been calculated by the knowing process.

The processes of intervention of the first, second and third embodiments of the invention are accompanied by a process ensuring the coherence of the automatic update of the content of the empty object when the identifier of an empty object is used by the process P in a station, i.e. a process of waiting out of necessity which suspends the current task being carried out and only resumes the same when the content of the empty object is known.

Each computer station comprises a local process, a protocol module and a monitor, such that each local process may be local, remote relative to another process of another station, or knowing for the calculation of the content of an empty object. Each computer station may comprise one or more local processes, each process having a protocol module and a monitor.

The invention is not limited to the embodiments described above, but extends to other embodiments. Thus, the methods developed can be used alternatively or in combination according to the performances desired.

1. Method of call management of remote procedures in object-oriented language, by an asynchronous communication, between a local process of one station and a remote process of another station, such a call comprising a request (RPC) of one of the processes (P1; P2), followed by a response (R-A) of the other process (P2; P1), characterized in that it consists:
a—in detecting the transmission of an empty object as a parameter of a request or of a response before sending of the same from a local process to a remote process (210, 710), the calculation of the content of this empty object and its being made available having been requested of a knowing process,
b—in processing the empty object with a view to making available the content of this object (212, 712) to the remote process, and
c—in proceeding to send the said request or response (108) following an appropriate condition of processing.

2. Method according to claim 1, characterized in that the method consists
a—in detecting the event that an empty object must be used by a local process (702) and suspending the execution of use of the empty object by the local process (704),
b-b1—in extracting the empty object comprising an identifier, the identifier of the knowing process capable of calculating and making available the content of the empty object (706),
b2—in transmitting to the knowing process a first message having first data comprising the identifier of the empty object and the identifier of the local process and requesting transmission to the local process of a second message having second data comprising the content and identifier of the empty object (708), and
c—in awaiting receipt of the second message by the local process and once this second message is received, in updating the empty object and continuing execution of the use.

3. Method according to claim 2, characterized in that the stage b2—consists furthermore of b2-1 in checking upon receipt of the first message by the knowing process whether the empty object identifier is in a second table comprising couples of data associating empty object identifiers and the content of these objects (716),
b2-2-i in the affirmative, in transmitting to the local process the second message (718)
b2-2-ii in the negative, in adding the first data to a first table comprising couples of data associating empty object identifiers and process identifiers (717).

4. Method according to claim 3, characterized in that the stage b2-2-ii consists furthermore, once the content of the empty object is made available (720), in
adding the second data to the second table (722),
transmitting the second message to the processes whose identifiers in the first table are associated with the empty object identifier (724).

5. Method according to claim 1, characterized in that the stage b—consists furthermore in that the local process awaits receipt of a message sent by the knowing process (212), the message comprising the content and identifier of the empty object, and upon receipt of this message, in continuing to the stage c with the updated empty object.

6. Method according to claim 1, characterized in that the stage b—consists furthermore in that the local process adds the empty object identifier associated with the identifier of the remote process to a table comprising couples of data associating empty object identifiers and process identifiers (712-2), and in continuing to stage c.

7. Method according to claim 6, characterized in that once sending has been executed, the stage c consists in
c1—waiting for the content of the empty object to become available in the local process (412), and
c2—once the content is available, sending the content and the identifier of the empty object to the processes whose identifiers in the said table are associated with the empty object identifier (414).

8. Method according to claim 1, characterized in that the stage b—consists furthermore, in the local process, in
b1—extracting from the empty object comprising an identifier the identifier of the knowing process capable of calculating and making available the content of the empty object, and
b2—transmitting to the knowing process a first message having first data comprising the empty object identifier associated with the identifier of the remote process, this message requesting that the knowing process transmit to the remote process a second message having second data comprising the empty object identifier associated with its content (712-3).

9. Method according to claim 8, characterized in that the stage c also consists in that the knowing process upon receipt of the first message
c1—add the first data to a table comprising couples of data associating empty object identifiers and process identifiers (712-3).

10. Method according to either of claim 8, characterized in that the stage c further consists in that the local process upon completion of sending
c1—wait for the content of the empty object to be available in the local process (612),
d2—once the content is available, send the empty object identifier associated with its content to the processes whose identifiers in the table are associated with the empty object identifier (614).

11. Computer station, comprising
an environment (ST1-2, ST1-4, ST1-6) capable of carrying out one or more local processes (P1) in object-oriented language,
a protocol module (ST1-6) capable of processing, by an asynchronous communication, remote procedure calls (RPC) between a local process (P1) and a remote process (P2) of another station, such a call (RPC) comprising a request (A) of one of the processes (P1; P2) followed by a response (R-A) of the other process (P2; P1), characterized in that it comprises a monitor (ST1-12) capable—upon detection of the event that an empty object is occurring as a parameter of a request or response to be sent by the local process (P1) to the remote process (P2), calculation of the content of this empty object and its being made available having been requested of a knowing process—
of processing the empty object with a view to making available the content of this object to the remote process,
proceeding to sending of the request or response upon an appropriate condition of processing.

12. Computer station according to claim 11, characterized in that the monitor (ST1-12) is further capable, upon detection of the event that an empty object must be used by the local process, of
extracting from the empty object comprising an identifier the identifier of a knowing process capable of calculating and making available the content of the empty object,
transmitting to the knowing process a first message having first data comprising the empty object identifier and the identifier of the local process and requesting the transmission to the local process of a second message having second data comprising the content and identifier of the empty object,
awaiting receipt of the second message by the local process, this receipt being the appropriate condition of processing.

13. Computer station according to claim 12, characterized in that the monitor (ST1-12) of the computer station of the knowing process being capable of
operating with a first table comprising couples of data associating empty object identifiers and process identifiers and a second table comprising couples of data associating empty object identifiers and the contents of these objects,
transmitting the second message
to the local process after checking that the empty object identifier of the first message is in the second table
to the processes whose identifier in the first table is associated with the empty object identifier after adding the first data to the first table and having added the second data to the second table after calculating the content of the empty object.

14. Computer station according to claim 11, characterized in that the monitor (ST1-12) is capable of awaiting receipt of a message sent by the knowing process, the message comprising the content and identifier of the empty object, such receipt being the appropriate condition of processing.

15. Computer station according to claim 11, characterized in that the monitor (ST1-12) is capable of adding the empty object identifier associated with the identifier of the remote process to a table comprising couples of data associating empty objects identifiers and process identifiers, this addition being the appropriate condition of processing.

16. Computer station according to claim 15, characterized in that once the content of the empty object is available in the local process, the monitor (ST1-12) is capable of transmitting the identifier and the content of the empty object to processes whose identifiers in the table are associated with the empty object identifier.

17. Computer station according to claim 11, characterized in that the monitor (ST1-12) is capable of:
extracting the empty object comprising an identifier, the identifier of a knowing process capable of calculating and making available the content of the empty object,
transmitting to the knowing process a first message having first data comprising the empty object identifier associated with the identifier of the remote process, this first message requesting transmission to the remote process of a second message having second data comprising the content and identifier of the empty object, the transmission of the first message being the appropriate condition of processing.

18. Computer station according to claim 17, characterized in that the monitor (ST1-12) of the computer station of the knowing process is capable upon receipt of the first message:
of adding the first data to a table comprising couples of data associating empty object identifiers and process identifiers.

19. Computer station according to claim 17, characterized in that the monitor of the computer station of the local process is capable, after carrying out sending of the request or response and once the content of the empty object is available in the local process, of sending the empty object identifier associated with its content to the processes whose identifiers in the table are associated with the empty object identifier (614).

20. Network of computer stations according to claim 11, each computer station comprising a local process, a protocol module and a monitor such that each local process can be local, remote relative to another process of another station, or knowing for calculating the content of an empty object.

21. Method according to claim 9, characterized in that the stage c further consists in that the local process upon completion of sending:
c1—wait for the content of the empty object to be available in the local process (612),
d2—once the content is available, send the empty object identifier associated with its content to the processes whose identifiers in the table are associated with the empty object identifier (614).

22. Computer station according to claim 18, characterized in that the monitor of the computer station of the local process is capable, after carrying out sending of the request or response and once the content of the empty object is available in the local process, of sending the empty object identifier associated with its content to the processes whose identifiers in the table are associated with the empty object identifier (614).
